(19) United States
(12) Patent Application Publication
(10) Pub. No.: US 2011/0151134 A1
(43) Pub. Date: Jun. 23, 2011

(54) METHOD FOR MANUFACTURING MICRO-NANO IMPRINT MOULD AND IMPRINTING PROCESS

(75) Inventors: Yu-Chih KAO, TAINAN CITY (TW); Yoou-Bin GUO, TAINAN CITY (TW); Chau-Nan HONG, TAINAN CITY (TW); Min-Hsiung HON, TAINAN CITY (TW)

(73) Assignee: NATIONAL CHENG KUNG UNIVERSITY, TAINAN CITY (TW)

(21) Appl. No.: 12/646,464

(22) Filed: Dec. 23, 2009

(51) Int. Cl. C08J 7/04; B28B 7/36

(52) U.S. Cl. 427/510; 427/133; 427/58; 427/569

(57) ABSTRACT

A method for manufacturing a micro-nano imprint mould and an imprinting process are described. The method for manufacturing a micro-nano imprint mould includes: providing a mould body including a first surface and a second surface on opposite sides, wherein the mould body includes an imprinting pattern structure set in the first surface, and the imprinting pattern structure includes a plurality of concaves and a plurality of convexes between the concaves; and performing a surface treatment step on the first surface of the mould body to make a first contact angle form between an imprint fluid and the concaves and a second contact angle form between the imprint fluid and the convexes, wherein the first contact angle is different from the second contact angle.

### FIELD OF THE INVENTION

The present invention relates to a method for manufacturing an imprint mould, and more particularly to a method for manufacturing a micro-nano imprint mould and an imprinting process by applying the micro-nano imprint mould.

### BACKGROUND OF THE INVENTION

A photolithography technique plays a very important role in a semiconductor process. Currently, as electronic devices are tending to miniaturize, the exposure wavelength used in the photolithography process is decreased gradually. However, due to the limit of light characteristic, process apparatuses and techniques of the photolithography process are more complex and more precise to achieve the transformation of micro-nano patterns. Therefore, the photolithography process has drawbacks of expensive apparatus cost and high technique risk. Furthermore, the photolithography will soon face the bottleneck of optical imaging technique.

A micro-nano imprinting technique is a new micro-nano process technique, which can be used to fabricate a pattern with a size of 10 nm or smaller. In a typical imprinting process, a polymer is heated, or a polymer or an inorganic matter is blended to form a solution to be an imprint fluid, the imprint fluid is then filled into a pattern structure on a surface of a mould, and the imprint fluid on the mould is transferred onto a substrate to transfer the pattern of the mould onto the substrate.

However, when the imprint fluid is filled into the mould by a spin-coating method, a solvent-assisting imprinting method or a hot embossing method, the imprint fluid remains on a convex of the pattern structure on the surface of the mould, so that the imprint fluid on the convex and the imprint fluid filled into a concave of the pattern structure of the mould of the mould form a continuous film. With such a continuous film, the desired pattern size cannot be accurately transferred, and the property difference between the pattern and the underlying substrate cannot be discriminated. For example, when a conductive pattern is transferred, the transferred pattern is continuous due to the existence of the continuous film, so that the conductive region and the insulation region cannot be discriminated. In addition, when the imprinting material is transferred onto the substrate, a portion of the continuous film has to be removed to remove the residual portion outside the desired pattern structure. When the pattern does not have a uniform thickness, a portion of the thinner area of the pattern is thinned during the process of removing the residual layer, so that the accuracy of the transferred pattern is seriously affected.

### SUMMARY OF THE INVENTION

Therefore, one aspect of the present invention is to provide a method for manufacturing a micro-nano imprint mould, which uses a surface treatment method to cause a difference between surface properties of convexes and concaves of the mould, so that an imprint fluid can selectively only enter the concaves of the mould but cannot stay on the convexes of the mould. Therefore, an objective of no residual layer can be achieved in the imprinting process, so that it can prevent the imprint fluid from becoming a continuous film after baking, save the problem of removing the residual layer and simplify the process.

Another aspect of the present invention is to provide an imprint process, which can greatly enhance the accuracy of the transferred pattern and effectively increase the yield of the imprinting process.

According to the aforementioned aspects, the present invention provides a method for manufacturing a micro-nano imprint mould including the following steps. A mould body including a first surface and a second surface on opposite sides is provided, wherein the mould body includes an imprinting pattern structure set in the first surface, and the imprinting pattern structure includes a plurality of concaves and a plurality of convexes between the concaves. A surface treatment step is performed on the first surface of the mould body to make a first contact angle form between an imprint fluid and the concaves and a second contact angle form between the imprint fluid and the convexes, wherein the first contact angle is different from the second contact angle.

According to a preferred embodiment of the present invention, a material of the mould body is silicon, the surface treatment step includes forming a silane film on the convexes, and the imprint fluid is an epoxy solution, wherein the second contact angle is 100 degrees, and the first contact angle is 60 degrees.

According to the aforementioned aspects, the present invention provides an imprinting process including the following steps. An imprint mould is provided, wherein the step of providing the imprint mould includes the following steps. A mould body including a first surface and a second surface on opposite sides is provided, wherein the mould body includes an imprinting pattern structure set in the first surface, and the imprinting pattern structure includes a plurality of concaves and a plurality of convexes between the concaves. A surface treatment step on the first surface of the mould body is performed to make a first contact angle form between an imprint fluid and the concaves and a second contact angle form between the imprint fluid and the convexes, wherein the first contact angle is different from the second contact angle. The imprint fluid is selectively only filled into the concaves by using a difference between the first contact angle and the second contact angle. When the imprint mould is provided, a substrate is provided. The imprint fluid in the concaves is transferred onto a surface of the substrate.

According to a preferred embodiment of the present invention, the step of providing the substrate further includes performing a surface treatment on the substrate to make the surface of the substrate have a special functional group. In one preferred embodiment, the surface treatment is a plasma treatment, an arc discharge treatment, a corona treatment, a heating treatment, an acidification treatment, an oxidization treatment or a sulfonation treatment.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1A and FIG. 1B are schematic flow diagrams showing a process for manufacturing a micro-nano imprint mould in accordance with a preferred embodiment of the present invention;

FIG. 2A and FIG. 2B are schematic flow diagrams showing a process for manufacturing a micro-nano imprint mould in accordance with another preferred embodiment of the present invention;

FIG. 3A through FIG. 3C are schematic flow diagrams showing an imprinting process in accordance with a preferred embodiment of the present invention; and

FIG. 4A through FIG. 4C are schematic flow diagrams showing an imprinting process in accordance with another preferred embodiment of the present invention.

### DETAILED DESCRIPTION OF THE PREFERRED EMBODIMENT

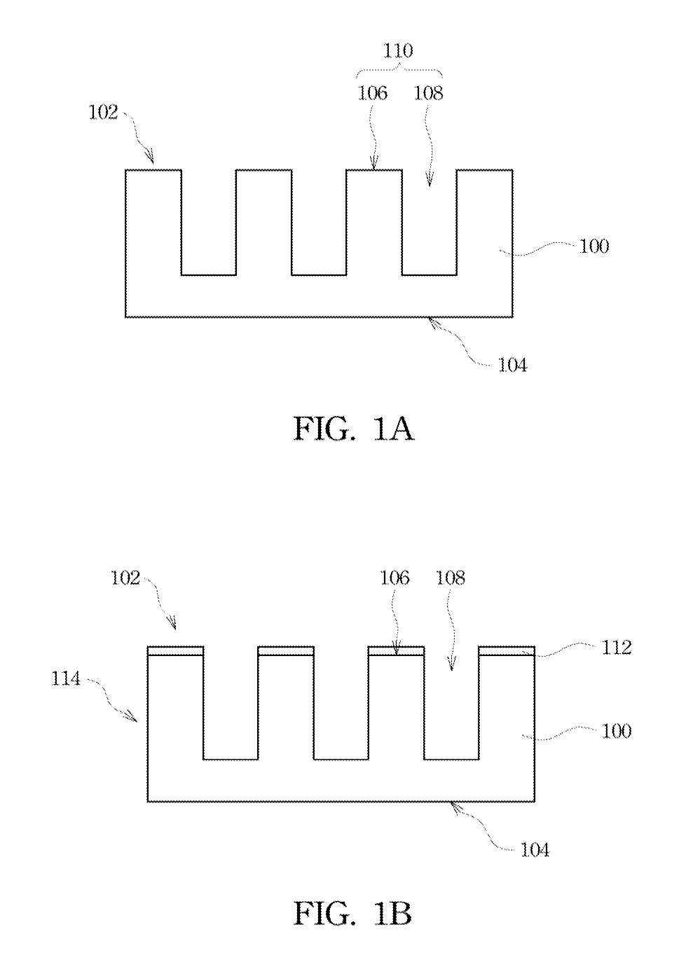

The present invention discloses method for manufacturing a micro-nano imprint mould and an imprinting process. In order to make the illustration of the present invention more explicit, the following description is stated with reference to FIG. 1A through FIG. 4C.

Refer to FIG. 1 and FIG. 1B. FIG. 1A and FIG. 1B are schematic flow diagrams showing a process for manufacturing a micro-nano imprint mould in accordance with a preferred embodiment of the present invention. In one exemplary embodiment, in the manufacture of a micro-nano imprint mould, a mould body 100 is provided. The mould body 100 includes surface 102 and 104 on two opposite sides, and a three-dimensional pattern structure 110 has been formed on the surface 102 of the mould body 100 according to a pattern to be transferred. The pattern structure 110 mainly includes a plurality of concaves 108 formed on the surface 102 of the mould body 100, and a plurality of convexes 106 between the concaves 108, such as shown in FIG. 1A. In the present exemplary embodiment, the size of the pattern structure 110 of the mould body 100 is in micrometer level or nanometer level. A material of the mould body 100 may be, for example, an inorganic material, an organic material, or a mixture of the inorganic material, and the organic material. In one embodiment, the mould body 100 may be composed of a solid material. In other embodiments, the mould body 100 may be composed of a porous material including a porous structure. In a preferred embodiment, the material of the mould body 100 may be silicon.

Next, a surface treatment step is performed on the surface 102 of the mould body 100 including the pattern structure 110 set thereon, so as to enable a contact angle to form between the concaves 108 of the pattern structure 110 and an imprint fluid desired to be imprinted subsequently, and to enable another contact angle to form between the convexes 106 of the pattern structure 110 and the imprint fluid. The contact angles between the imprint fluid and the concaves 108 and between the imprint fluid and the convexes 106 must be different, and the difference between the two contact angles between the imprint fluid and the concaves 108 and between the imprint fluid and the convexes 106 is preferably greater than or equal to 5 degrees. The contact angles between the imprint fluid and the concaves 108 and between the imprint fluid and the convexes 106 are different, so the imprint fluid can selectively enter the concaves 108 of the mould body 100 but cannot be adhered to the convexes 106 of the mould body 100.

In one embodiment, in the surface treatment step, a surface modified film may be formed only on the convexes 106 of the pattern structure 110, wherein the surface modified film may be an inorganic film, an organic film, or a mixture film composed of an organic material and an inorganic material. In another embodiment, in the surface treatment step, a surface modified film may be formed only on the concaves 108 of the pattern structure 110, wherein the surface modified film may be an inorganic film, an organic film, or a mixture film composed of an organic material and an inorganic material. In still another embodiment, in the surface treatment step, different surface modified films may be respectively formed on the convexes 106 and the concave 108 of the pattern structure 110, wherein the different surface modified films may be, for example, different silane films.

As shown in FIG. 1B, in the present exemplary embodiment, in the surface treatment step, a surface modified film 112 is formed only on the convexes 106 of the pattern structure 110. After the surface treatment step of the surface 102 of the mould body 100 is completed, the manufacturing of a micro-nano imprint mould 114 is substantially completed. In one embodiment, the material of the mould body 100 is silicon, the surface modified film 112 is a silane film, the imprint fluid is an epoxy solution, a contact angle between the convexes 106 of the mould body 100 and the imprint fluid is 100 degrees, and a contact angle between the concaves 108 of the mould body 100 and the imprint fluid is 60 degrees.

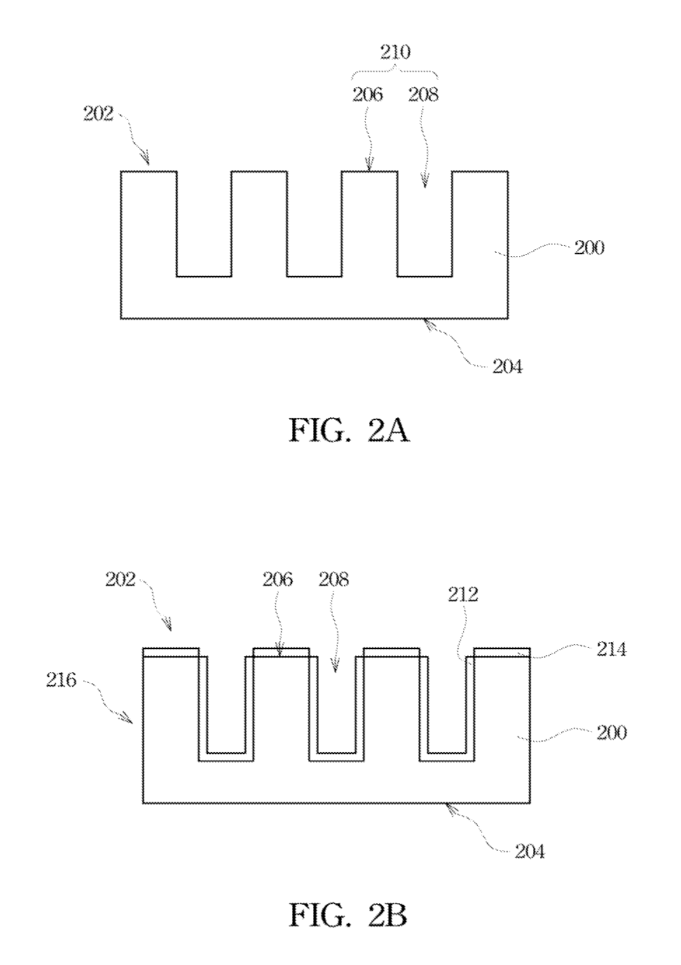

Refer to FIG. 2A and FIG. 2B. FIG. 2A and FIG. 2B are schematic flow diagrams showing a process for manufacturing a micro-nano imprint mould in accordance with another preferred embodiment of the present invention. In the present exemplary embodiment, in the manufacture of a micro-nano imprint mould, a mould body 200 is provided. The mould body 200 includes surface 202 and 204 on two opposite sides, and a three-dimensional pattern structure 210 has been formed on the surface 202 of the mould body 200. The pattern structure 210 mainly includes a plurality of concaves 208 formed on the surface 202 of the mould body 200, and a plurality of convexes 206 between the concaves 208, such as shown in FIG. 2A. In the present exemplary embodiment, the size of the pattern structure 210 of the mould body 200 is in micrometer level or nanometer level. A material of the mould body 200 may be, for example, an inorganic material, an organic material, or a mixture of an inorganic material and an organic material. The mould body 200 may be composed of a solid material or a porous material including a porous structure.

Next, a surface treatment step is performed on the surface 202 of the mould body 200, so as to enable a contact angle to form between the concaves 208 of the pattern structure 210 and an imprint fluid desired to be imprinted subsequently, and to enable another contact angle to form between the convexes 206 of the pattern structure 210 and the imprint fluid. The contact angles between the imprint fluid and the concaves 208 and between the imprint fluid and the convexes 206 must be different, and the difference between the two contact angles between the imprint fluid and the concaves 208 and between the imprint fluid and the convexes 206 is preferably greater than or equal to 5 degrees.

As shown in FIG. 2B, in the present exemplary embodiment, in the surface treatment step, a surface modified film 214 is formed on the convexes 206 of the pattern structure 210, and a surface modified film 212 is formed on the concaves 208 of the pattern structure 210. After the surface treatment step of the surface 202 of the mould body 200 is completed, the manufacturing of a micro-nano imprint mould 216 is substantially completed. In one embodiment, the material of the mould body 200 is silicon, the surface modified film 212 is a trichloro(1H,1H,2H,2H-perfluorooctyl)silane film, the surface modified film 214 is an octadecyltrichlorosilane film, the imprint fluid is a polymer/chloroform solution or a polymer/chlorobenzene solution, such as a PMMA/chloroform solution, a contact angle between the convexes 206 of the mould body 200 and the imprint fluid is 65 degrees, and a contact angle between the concaves 208 of the mould body 200 and the imprint fluid is 70 degrees. The contact angles between the imprint fluid and the convexes 206 and between the imprint fluid and the concaves 208 are different, so the imprint fluid can selectively enter the concaves 208 of the mould body 200 but cannot be adhered to the convexes 206 of the mould body 200.

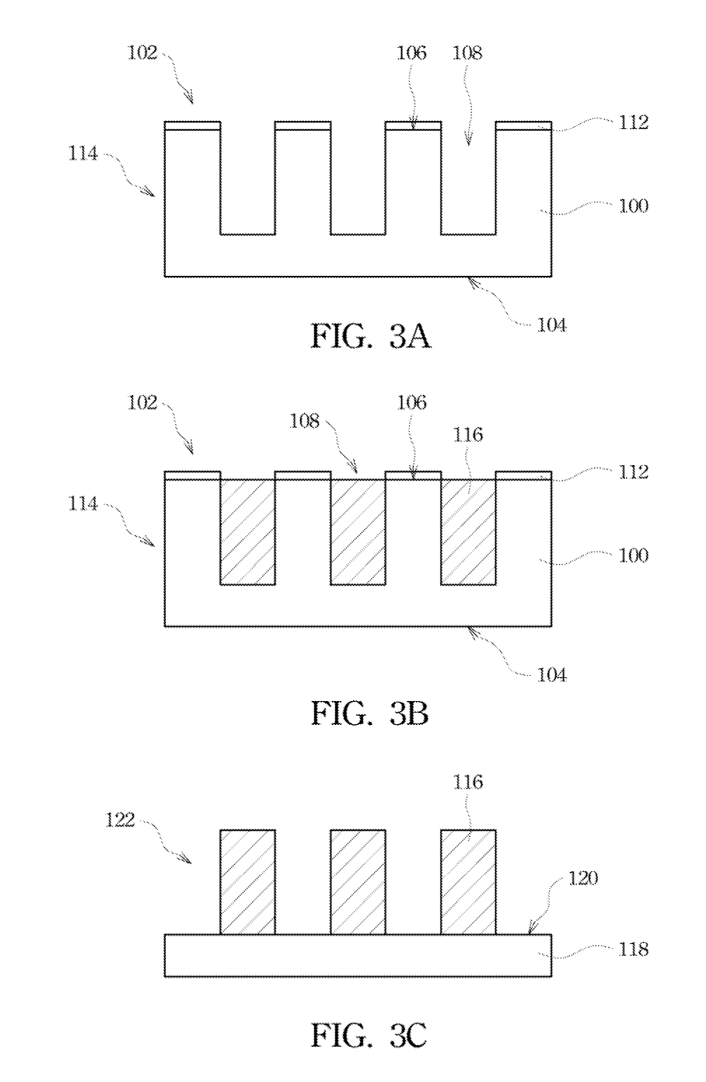

After the micro-nano imprint mould is formed, the micro-nano imprint mould can be used to perform an imprinting process. FIG. 3A through FIG. 3C are schematic flow diagrams showing an imprinting process in accordance with a preferred embodiment of the present invention. As shown in FIG. 3A, in the present exemplary embodiment, when an imprinting process is performed, an imprint mould, such as the micro-nano imprint mould 114 shown in FIG. 1B, is provided. Then, with the difference of the contact angles between the imprint fluid 116 and the convexes 106 of the mould body 100 and between the imprint fluid 116 and the concaves 108 of the mould body 100, the imprint fluid 116 can selectively enter the concaves 108 of the pattern structure 110 but cannot be adhered to the convexes 106 of the mould body 100, such as shown in FIG. 3B. For example, an immersion method, an absorption method, a coating method, a hot embossing method or a solvent-assisting imprinting method may be used to fill the imprint fluid 116 into the concaves 108 of the pattern structure 110 of the mould body 100. The imprint fluid 116 may be an inorganic compound, an organic compound, or a mixture of an inorganic material and an organic material. The organic compound may be a reactive material, a nonreactive material, or a mixture material composed of a reactive material and a nonreactive material. The organic compound may be a polymer, a polymer monomer, or a mixture composed of a polymer and a polymer monomer.

Next, a substrate 118 to be imprinted is provided, wherein a material of the substrate 118 may be an inorganic material, an organic material, or a mixture of an inorganic material and an organic material. In one embodiment, a surface treatment procedure is performed on a surface 120 of the substrate 118 to make the surface 120 of the substrate 118 have a special functional group, so as to modify the surface property of the surface 120 of the substrate 118. The special functional group may be a hydroxyl group (—OH), a carboxyl group (—COOH), an amine group (—NH₂), an amide group (—H—N—C═O), or a mixture of the aforementioned groups. A plasma treatment method, an arc discharge method, a corona treatment method, a heating treatment method, an acidification treatment method, an oxidization treatment method or a sulfonation treatment method may be used to perform the surface treatment of the substrate 118.

Then, the imprint fluid 116 in the concaves 108 of the micro-nano imprint mould 114 is transferred onto the surface 120 of the substrate 118, and the micro-nano imprint mould 114 is removed to successfully transfer the pattern of the micro-nano imprint mould 114 onto the substrate 118 to complete the imprinting process, such as shown in FIG. 3C. In one embodiment, when the imprint fluid 116 in the concaves 108 is transferred onto the substrate 118, an initiation polymerization treatment may be firstly performed on the imprint fluid 116 in the concaves 108 by, for example, a heating method or an ultraviolet irradiation method. Then, the surface 102 of the mould body 100 are oppositely connected to the surface 120 of the substrate 118 to adhere the imprint fluid 116 to the surface 120 of the substrate 118, and the mould body 100 is removed. In another embodiment, when the imprint fluid 116 in the concaves 108 is transferred onto the substrate 118, the surface 102 of the mould body 100 are oppositely connected to the surface 120 of the substrate 118 to adhere the imprint fluid 116 to the surface 120 of the substrate 118. Then, an initiation polymerization treatment may be performed on the imprint fluid 116 in the concaves 108 by, for example, a heating method or an ultraviolet irradiation method, and the mould body 100 is removed.

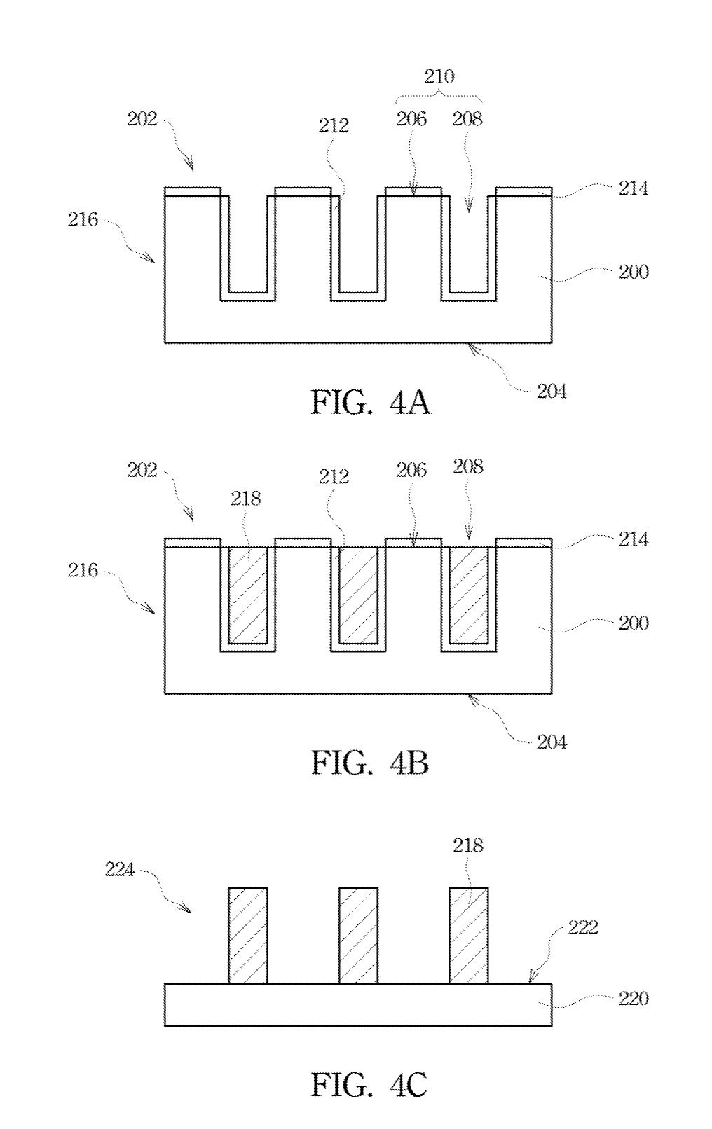

FIG. 4A through FIG. 4C are schematic flow diagrams showing an imprinting process in accordance with another preferred embodiment of the present invention. As shown in FIG. 4A, in the present exemplary embodiment, when an imprinting process is performed, an imprint mould, such as the micro-nano imprint mould 216 shown in FIG. 2B, is provided. Then, with the difference of the contact angles between the imprint fluid 218 and the convexes 206 of the mould body 200 and between the imprint fluid 218 and the concaves 208 of the mould body 200, the imprint fluid 218 can selectively enter the concaves 208 of the pattern structure 210 but cannot be adhered to the convexes 206 of the pattern structure 210, such as shown in FIG. 4B. For example, an immersion method, an absorption method, a coating method, a hot embossing method or a solvent-assisting imprinting method may be used to fill the imprint fluid 218 into the concaves 208 of the pattern structure 210. The imprint fluid 218 may be an inorganic compound, an organic compound, or a mixture of an inorganic material and an organic material. The organic compound may be a reactive material, a nonreactive material, or a mixture material composed of a reactive material and a nonreactive material. The organic compound may be a polymer, a polymer monomer, or a mixture composed of a polymer and a polymer monomer.

Then, a substrate 220 to be imprinted is provided, wherein a material of the substrate 220 may be an inorganic material, an organic material, or a mixture of an inorganic material and an organic material. Similarly, a surface treatment procedure is performed on a surface 222 of the substrate 220 to make the surface 222 of the substrate 220 have a special functional group, so as to modify the surface property of the surface 222 of the substrate 220. Subsequently, the imprint fluid 218 in the concaves 208 of the micro-nano imprint mould 216 is transferred onto the surface 222 of the substrate 220, and the micro-nano imprint mould 216 is removed to successfully transfer the pattern of the micro-nano imprint mould 216 onto the substrate 220 to complete the imprinting process, such as shown in FIG. 4C.

According to the aforementioned embodiments, one advantage of the present invention is that a method for manufacturing a micro-nano imprint mould of the present invention uses a surface treatment method to cause a difference between surface properties of convexes and concaves of the mould, so that an imprint fluid can selectively only enter the concaves of the mould but cannot be adhered to the convexes of the mould. Therefore, an objective of no residual layer can be achieved in the imprinting process, so that it can prevent the imprint fluid from becoming a continuous film after baking, save the problem of removing the residual layer and simplify the process.

According to the aforementioned embodiments, another advantage of the present invention is that an imprint process of the present invention does not have a residual layer problem. Accordingly, the accuracy of the transferred pattern can be greatly enhanced, and the yield of the imprinting process can be effectively increased.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a micro-nano imprint mould, including:
providing a mould body including a first surface and a second surface on opposite sides, wherein the mould body includes an imprinting pattern structure set in the first surface, and the imprinting pattern structure includes a plurality of concaves and a plurality of convexes between the concaves; and
performing a surface treatment step on the first surface of the mould body to make a first contact angle form between an imprint fluid and the concaves and a second contact angle form between the imprint fluid and the convexes, wherein the first contact angle is different from the second contact angle.

2. The method for manufacturing a micro-nano imprint mould according to claim 1, wherein a difference between the first contact angle and the second contact angle is greater than or equal to 5 degrees.

3. The method for manufacturing a micro-nano imprint mould according to claim 1, wherein a material of the mould body is an inorganic material, an organic material, or a mixture of the inorganic material and the organic material.

4. The method for manufacturing a micro-nano imprint mould according to claim 1, wherein the mould body is composed of a solid material.

5. The method for manufacturing a micro-nano imprint mould according to claim 1, wherein the mould body is composed of a porous material.

6. The method for manufacturing a micro-nano imprint mould according to claim 1, wherein the surface treatment step includes forming an inorganic film, an organic film, or a mixture film composed of an organic material and an inorganic material on the convexes of the mould body.

7. The method for manufacturing a micro-nano imprint mould according to claim 1, wherein the surface treatment step includes forming an inorganic film, an organic film, or a mixture film composed of an organic material and an inorganic material on the concaves of the mould body.

8. The method for manufacturing a micro-nano imprint mould according to claim 1, wherein a material of the mould body is silicon.

9. The method for manufacturing a micro-nano imprint mould according to claim 8, wherein the surface treatment step includes forming different silane films respectively on the convexes and the concaves.

10. The method for manufacturing a micro-nano imprint mould according to claim 8, wherein the surface treatment step includes forming a silane film on the convexes.

11. The method for manufacturing a micro-nano imprint mould according to claim 10, wherein the imprint fluid is an epoxy solution.

12. The method for manufacturing a micro-nano imprint mould according to claim 11, wherein the second contact angle is 100 degrees.

13. The method for manufacturing a micro-nano imprint mould according to claim 12, wherein the first contact angle is 60 degrees.

14. The method for manufacturing a micro-nano imprint mould according to claim 8, wherein the surface treatment step includes forming an octadecyltrichlorosilane film on the convexes.

15. The method for manufacturing a micro-nano imprint mould according to claim 14, wherein the surface treatment step includes forming a trichloro(1H,1 H,2H,2H-perfluorooctyl)silane film on the concaves.

16. The method for manufacturing a micro-nano imprint mould according to claim 15, wherein the imprint fluid is a polymer/chloroform solution or a polymer/chlorobenzene solution.

17. The method for manufacturing a micro-nano imprint mould according to claim 16, wherein the second contact angle is 65 degrees.

18. The method for manufacturing a micro-nano imprint mould according to claim 17, wherein the first contact angle is 70 degrees.

19. An imprinting process, including:
providing an imprint mould, wherein the step of providing the imprint mould includes:
providing a mould body including a first surface and a second surface on opposite sides, wherein the mould body includes an imprinting pattern structure set in the first surface, and the imprinting pattern structure includes a plurality of concaves and a plurality of convexes between the concaves; and
performing a surface treatment step on the first surface of the mould body to make a first contact angle form between an imprint fluid and the concaves and a second contact angle form between the imprint fluid and the convexes, wherein the first contact angle is different from the second contact angle;
selectively filling the imprint fluid only into the concaves by using a difference between the first contact angle and the second contact angle;
providing a substrate; and
transferring the imprint fluid in the concaves onto a surface of the substrate.

20. The imprinting process according to claim 19, wherein the difference between the first contact angle and the second contact angle is greater than or equal to 5 degrees.

21. The imprinting process according to claim 19, wherein a material of the mould body is an inorganic material, an organic material, or a mixture of the inorganic material and the organic material.

22. The imprinting process according to claim 19, wherein the mould body is composed of a solid material.

23. The imprinting process according to claim 19, wherein the mould body is composed of a porous material.

24. The imprinting process according to claim 19, wherein the surface treatment step includes forming an inorganic film, an organic film, or a mixture film composed of an organic material and an inorganic material on the convexes of the mould body.

25. The imprinting process according to claim 19, wherein the surface treatment step includes forming an inorganic film, an organic film, or a mixture film composed of an organic material and an inorganic material on the concaves of the mould body.

26. The imprinting process according to claim 19, wherein a material of the mould body is silicon.

27. The imprinting process according to claim 26, wherein the surface treatment step includes forming a silane film on the convexes.

28. The imprinting process according to claim 27, wherein the imprint fluid is an epoxy solution.

29. The imprinting process according to claim 28, wherein the second contact angle is 100 degrees.

30. The imprinting process according to claim 29, wherein the first contact angle is 60 degrees.

31. The imprinting process according to claim 26, wherein the surface treatment step includes forming an octadecyltrichlorosilane film on the convexes.

32. The imprinting process according to claim 31, wherein the surface treatment step includes forming a trichloro(1H,1H,2H,2H-perfluorooctyl)silane film on the concaves.

33. The imprinting process according to claim 32, wherein the imprint fluid is a polymer/chloroform solution or a polymer/chlorobenzene solution.

34. The imprinting process according to claim 33, wherein the second contact angle is 65 degrees.

35. The imprinting process according to claim 34, wherein the first contact angle is 70 degrees.

36. The imprinting process according to claim 19, wherein the step of filling the imprint fluid only into the concaves includes using an immersion method, an absorption method, a coating method, a hot embossing method or a solvent-assisting imprinting method.

37. The imprinting process according to claim 19, wherein the imprint fluid is an organic compound, an inorganic compound, or a mixture of an inorganic material and an organic material.

38. The imprinting process according to claim 37, wherein the organic compound is a reactive material, a nonreactive material, or a mixture material composed of a reactive material and a nonreactive material.

39. The imprinting process according to claim 37, wherein the organic compound is a polymer, a polymer monomer, or a mixture composed of a polymer and a polymer monomer.

40. The imprinting process according to claim 19, wherein a material of the substrate is an inorganic material, an organic material, or a mixture of the inorganic material and the organic material.

41. The imprinting process according to claim 19, wherein the step of providing the substrate further includes performing a surface treatment on the substrate to make the surface of the substrate have a special functional group.

42. The imprinting process according to claim 41, wherein the surface treatment is a plasma treatment, an arc discharge treatment, a corona treatment, a heating treatment, an acidification treatment, an oxidization treatment or a sulfonation treatment.

43. The imprinting process according to claim 41, wherein the special functional group is a hydroxyl group (—OH), a carboxyl group (—COOH), an amine group (—NH₂), an amide group (—H—N—C═O), or a mixture of the aforementioned groups.

44. The imprinting process according to claim 19, wherein the step of transferring the imprint fluid onto the substrate includes:
performing an initiation polymerization treatment on the imprint fluid in the concaves;
after the initiation polymerization treatment, oppositely connecting the first surface of the mould body to the surface of the substrate to adhere the imprint fluid to the surface of the substrate; and
removing the mould body.

45. The imprinting process according to claim 44, wherein the initiation polymerization treatment is performed by a heating method or an ultraviolet irradiation method.

46. The imprinting process according to claim 19, wherein the step of transferring the imprint fluid onto the substrate includes:
oppositely connecting the first surface of the mould body to the surface of the substrate to adhere the imprint fluid to the surface of the substrate;
performing an initiation polymerization treatment on the imprint fluid in the concaves after the mould body being connected to the substrate; and
removing the mould body.

47. The imprinting process according to claim 46, wherein the initiation polymerization treatment is performed by a heating method or an ultraviolet irradiation method.
